(19) United States
(12) Patent Application Publication
(10) Pub. No.: US 2018/0006937 A1
(43) Pub. Date: Jan. 4, 2018

(54) PACKET FORWARDING IN INFORMATION CENTRIC NETWORKING NETWORKS

(71) Applicant: FUJITSU LIMITED, Kawasaki-shi (JP)

(72) Inventors: Lei LIU, San Jose, CA (US); Akira ITO, San Jose, CA (US)

(73) Assignee: FUJITSU LIMITED, Kawasaki-shi (JP)

(21) Appl. No.: 15/199,577

(22) Filed: Jun. 30, 2016

(51) Int. Cl. H04L 12/741

(52) U.S. Cl. CPC H04L 45/74

(57) ABSTRACT

A method of forwarding information in an information centric networking (ICN) network may be provided. A method may include determining a hit rate for each detected network device of one or more detected network devices. The method may further include selecting at least one network device of the one or more detected network devices having a greatest hit rate. Further, the method may include sending an interest packet to the at least one selected network device.

### FIELD

The embodiments discussed herein are related to forwarding protocols in information centric networking networks.

### BACKGROUND

The Internet is currently based on an Internet Protocol (IP) structure, with a frame of reference of where content is located, for example, at a given IP address. In information centric networking (ICN) networks, the frame of reference is based on what content is requested, rather than where the content is located.

The subject matter claimed herein is not limited to embodiments that solve any disadvantages or that operate only in environments such as those described above. Rather, this background is only provided to illustrate one example technology area where some embodiments described herein may be practiced.

### SUMMARY

One or more embodiments of the present disclosure may include methods of forwarding information in information centric networking (ICN) networks. In one embodiment, a method may include determining a hit rate for each detected network device of one or more detected network devices. The method may further include selecting at least one network device of the one or more detected network devices having a greatest hit rate. Further, the method may include sending an interest packet to the at least one selected network device.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 is a diagram representing an example system for forwarding a packet in an information centric networking (ICN) network;

FIG. 2 is a diagram representing another example system for forwarding a packet in an ICN network;

FIGS. 3A and 3B are block diagrams of an example network device;

FIG. 4 is an example network device including a content store, a pending interest table, a forwarding information base, and a hit rate table;

FIG. 5 is an example hit rate table;

FIG. 6 is a flowchart of an example method for assigning an interface ID in an ICN network;

FIG. 7 is a flowchart of an example method for updating a hit rate table of a network device in an ICN network;

FIG. 8 is a flowchart of an example method for forwarding a packet in an ICN network; and

FIG. 9 is a block diagram of an example computing device.

### DESCRIPTION OF EMBODIMENTS

Communication environments, which include, for example, disrupted network connections, intermittent network connections, low bandwidth network connections and/or network connections with large round-trip time (RTT), may be referred to herein as “challenged communication environments.” How applications operate in such environments, regardless of the challenging nature of the environment, is an important issue. ICN, and named data networking (NDN), which is the most prominent realization of ICN, have emerged as promising solutions for addressing problems in challenged communication environments.

Various embodiments relate to ICN enabled packet forwarding (e.g., for challenged communication environments). In one embodiment, a “hit-aware multicast” may support packet forwarding in challenged communication environments. This embodiment may be enabled via a “hit rate table” that includes a “hit rate” for each forwarding interface in each network device (e.g., NDN device). A forwarding interface may be bound with a unique identifier of a network device and, thus, by multicasting an interest packet to forwarding interfaces (also referred to herein as “faces”) with the greatest hit rate, the network devices better suited to carry the information may be selected, thus improving the forwarding efficiency in challenged communication environments.

As used herein, an “interest packet” or an “interest” is a request packet from a consumer requesting content. Further, a “data packet” or “data” is a message that includes the content. Both interest and data packets may include a NAME field that describes the name of the content requested or carried.

In some embodiments, a “network device” may comprise a “data mule,” which is a disruption tolerant network (DTN) term for a device that physically carries information between remote locations to effectively create a communication link.

Embodiments of the present disclosure are now explained with reference to the accompanying drawings.

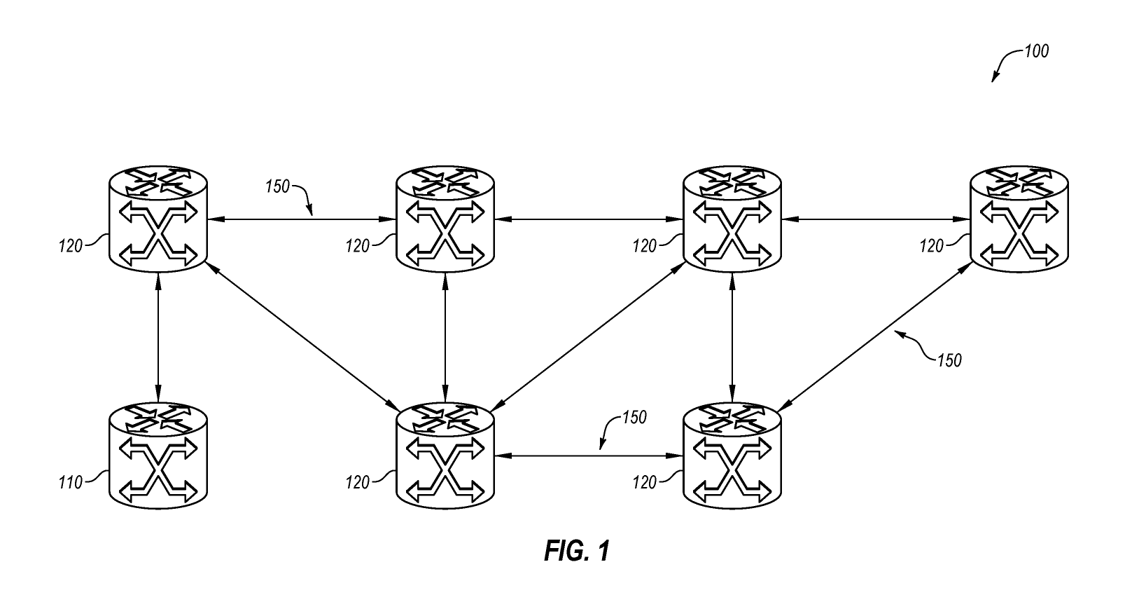

FIG. 1 is a diagram representing an example system 100 for handling packets in an ICN network, according to at least one embodiment of the present disclosure. System 100 may include a data consumer 110, one or more network devices 120, and a network 150.

In some embodiments, system 100 may be an ICN network. In these and other embodiments, data consumer 110 may request data via an interest packet. Furthermore, one or more of network devices 120 may generate a data packet, which is a packet that provides data (also referred to herein as “content”) as requested by an interest packet.

Data consumer 110 may include any device, system, component, or collection of components configured to request content. Data consumer 110 may be implemented as a computer (such as a desktop, laptop, server, etc.), as a mobile device (such as a cellular telephone, personal digital assistant (PDA), tablet, etc.), or as any other device connected to a network (e.g., a network-enabled thermostat, refrigerator, or other appliance). Data consumer 110 may include a processor, a memory, and a storage media. By way of example, during operation in network 150, data consumer 110 may send an interest packet to a network device 120. Because network 150 is operating as an ICN network, the interest packet may not indicate where the desired content is located, but instead may name the content desired by data consumer 110.

Network devices 120 may each include any device, system, component, or collection of components configured to receive, handle, and/or process packets within network 150. Network devices 120 may each be implemented as a router, a gateway, a switch, or any other network element. More specifically, for example, in one embodiment, network devices 120 may include one or more data mules, one or more NDN routers, or any combination thereof.

In some embodiments, network devices 120 may each include a processor, a memory, and a storage media. Network devices 120 may each also include one or more interfaces over which network devices 120 communicate. An interface may include a physical and/or logical entrance or exit point for communication with a network device.

In some embodiments, network devices 120 may each include a content store, a pending interest table (PIT), a forwarding information base (FIB), and a hit rate table. The content store, PIT, and FIB may be physical or logical storage components or locations within the memory and/or the storage media of the network devices 120.

In some embodiments, a content store may operate as a storage location for content which has been requested by another device in network 150. By implementing one or more network devices in network 150 with content stores, content that is frequently requested may be located in the content stores of multiple network devices and may be provided to devices requesting the content more quickly and/or efficiently.

In some embodiments, the PIT may serve as a status indicator of what interest packets have been received by a network device for which the network device is still awaiting a content packet. For example, the PIT may have table entries associating requested content with interfaces of the network device that have received interest packets requesting the content. The PIT may be used when a data packet is received by the network device to identify which interfaces have requested that content so the data packet may be sent out from the network device on the interfaces that requested the content, referred to as requesting interfaces.

Network 150 may include any device, system, component, or combination thereof configured to provide communication between data consumer 110 and network devices 120. By way of example, network 150 may include one or more wide area networks (WANs) or local area networks (LANs) in communication. In some embodiments, network 150 may include the Internet, including a global internetwork formed by logical and physical connections between multiple WANs and/or LANs. Additionally or alternatively, network 150 may include one or more cellular RF networks and/or one or more wired and/or wireless networks such as, but not limited to, 802.xx networks, Bluetooth® access points, wireless access points, IP-based networks, or the like. Network 150 may also include servers, substations, or other connection devices that enable one type of network to interface with another type of network. Additionally or alternatively, network 150 may include an Intranet, or one or more computing devices in communication within an organization or an in otherwise secure manner.

As noted above, challenged communication environments may include, for example disrupted environments, intermittently connected environments, low bandwidth environments, and/or environments with large round-trip time (RTT). More specifically, for example, challenged communication environments may include a communication environment after a disaster (e.g. earthquake), an environment with intermittent connectivity (e.g. village), an army tactical network, a first responder communication network, an interplanetary network, etc.

NDN and content centric networking (CCN) may focus on information (e.g., named data) retrieval, instead of reachability between nodes and locations. Therefore, NDN and/or CCN may circumvent a lack of persistent connectivity in challenged environments by focusing on moving data (e.g., via utilizing any connectivity, as it comes into existence, to move data hop-by-hop towards requesting parties) instead of end-to-end connectivity.

In one example environment, such as a national park, connectivity among sparsely deployed network devices (e.g., NDN routers) may be limited or nonexistent. For example, only one deployed network device at a gate of the national park may have Internet access. In this example, a visitor (e.g., having a car, cell phone, etc.) may serve as a “data mule.” This example may employ a “store-carry-and-forward” process.

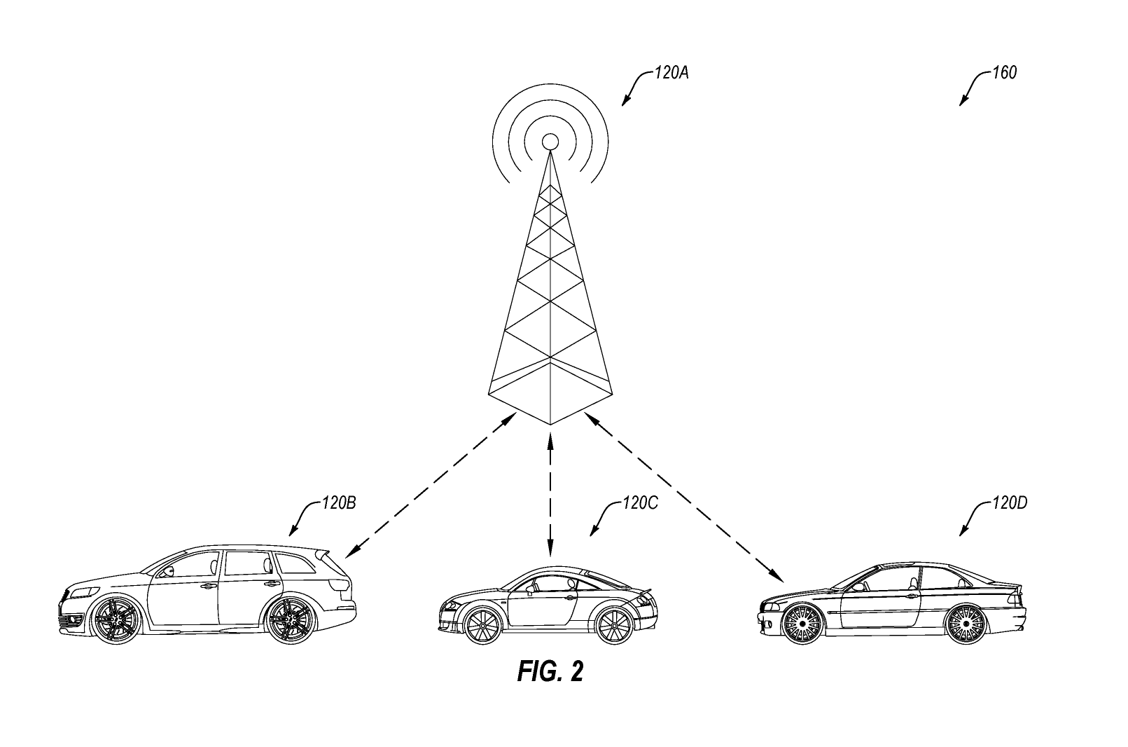

FIG. 2 is a diagram representing an example system 160, according to at least one embodiment of the present disclosure. System 160 includes network devices 120A, 120B, and 120C. In this example, network device 120A includes a router (e.g., an NDN router), and network devices 120B, 120C and 120D include data mules, each of which being configured to physically carry information between remote locations to effectively create a communication link.

In some embodiments, efficiency may be increased by increasing a number of devices that can serve as data mules in challenged communication environments. Example use cases for various embodiments disclosed herein include Internet/service provisioning in national parks and Internet/service provisioning in disaster areas.

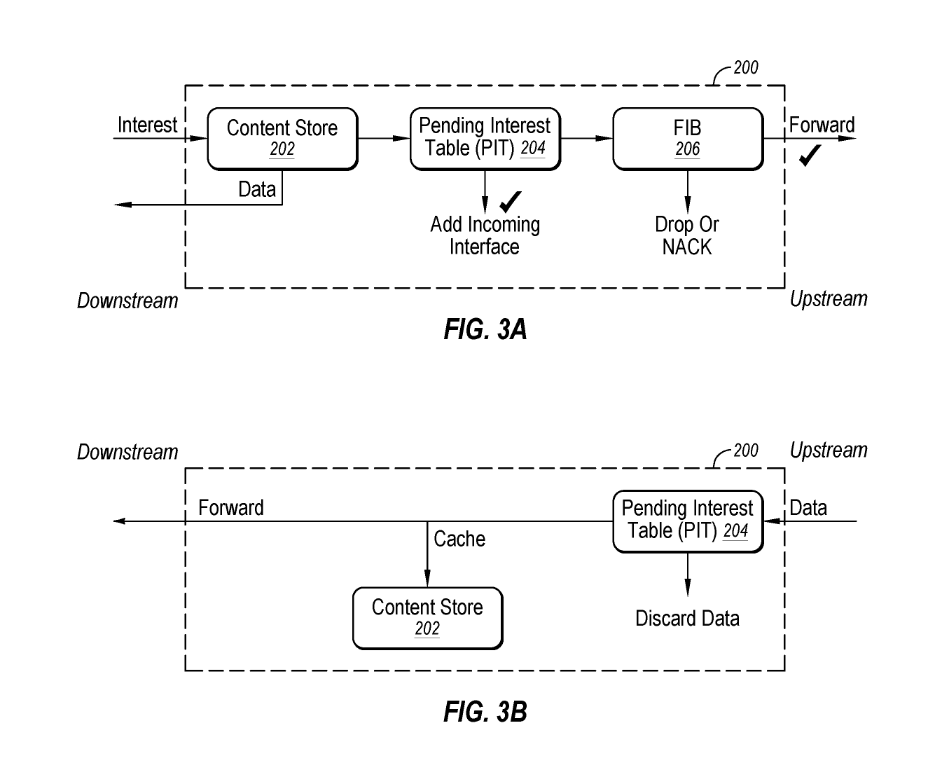

FIG. 3A depicts a network device 200 including a content store 202, a PIT 204, and a FIB 206. For example, upon an interest packet arriving at network device 200, network device 200 may check content store for matching data. If matching data exists, network device 200 may return the data packet on the interface from which the interest packet was received. Otherwise, network device 200 may look up the name in PIT 204, and if a matching entry exists, network device 200 may record the incoming interface of the interest packet in an entry of PIT 204. In the absence of a matching PIT entry, network device 200 may forward the interest packet toward the data producer(s) based on information in FIB 206. When a network device receives interest packets for the same name from multiple downstream nodes, the network device may forward only the first one upstream toward the data producer(s). FIB 206 may be populated by a name-prefix based routing protocol, and may have multiple output interfaces for each prefix.

FIG. 3B is another depiction of network device 200 including content store 202 and PIT 204. For example, upon a data packet arriving at network device 200, network device 200 may identify the matching PIT entry and forward the data packet to all downstream interfaces listed in that PIT entry. Network device 200 may remove that PIT entry, and cache the data in content store 202. Data packets may take the reverse path of interest packets, and, in the absence of packet losses, one interest packet results in one data packet on each link, providing flow balance.

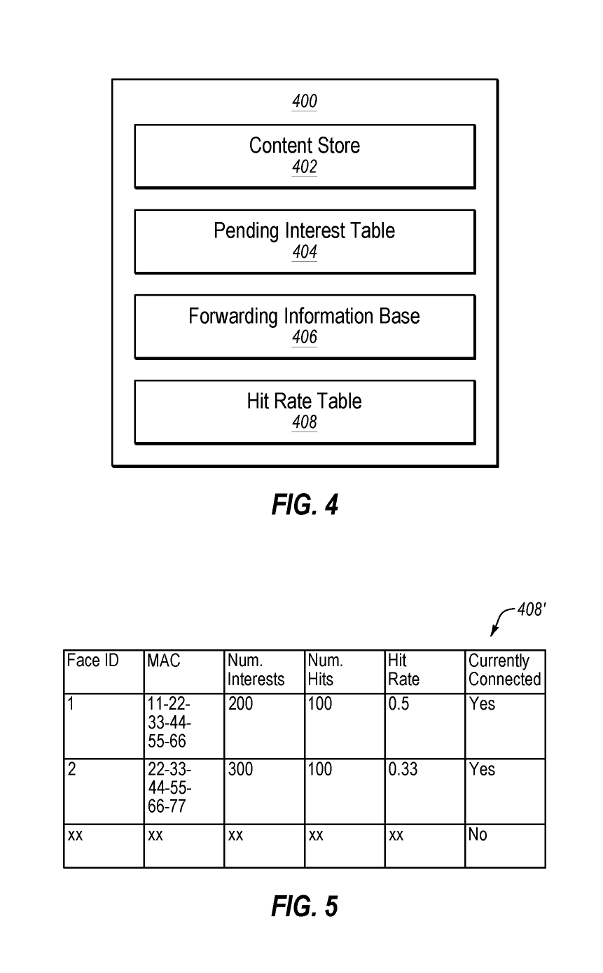

FIG. 4 illustrates an example network device 400. Device 400 includes a content store 402, a PIT 404, an FIB 406, and a hit rate table 408. Hit rate table 408 of device 400, which may comprise a router (e.g., an NDN router), may include information relating to other network devices (e.g., data mules) within a network. FIG. 5 depicts an example hit rate table 408′.

According to various embodiments, hit rate table 408′ may include a number of total interests (“Num. Interests”) forwarded to a data mule, a number of data packets received at network device 400 in response to one or more sent interest packets (i.e. “Num. Hits”), as well as the “hit rate” for each interface (“Face”) for each data mule within a network. In one embodiment, hit rate table 308′ may include information for data mules that are detected by (e.g., in communication with) network device 400. It is noted that a “Face” may comprise a logical interface.

With continued reference to FIG. 5, each interface ID (“Face ID”) may be bound to a unique device identifier (e.g. a MAC address). For a MAC address, the same Face ID may be assigned.

For a (e.g., newly detected) network device (e.g., data mule) with a new MAC address, a new interface ID may be assigned to the network device. Assignment of interfaces may be made in an incremental manner. For example, the first network device may be assigned to “Face 1,” a second network device may be assigned to “Face 2,” and so on.

For each network device, an interface ID assignment history may be cleared after a time interval, depending on the use case. For example, for a national park scenario, a time interval may be set to, for example, three days, as most of data mules may not stay in the national park for more than three days.

FIG. 5 is a flowchart of an example method 500 for assigning an interface ID (e.g., in a hit rate table of a network device), in accordance with at least one embodiment of the present disclosure. Method 500 may be performed by any suitable system, apparatus, or device. For example, system 100 of FIG. 1, system 160 of FIG. 2, or one or more of the components thereof may perform one or more of the operations associated with method 500. In these and other embodiments, program instructions stored on a computer readable medium may be executed to perform one or more of the operations of method 500.

At block 502, a network device may attempt to detect one or more network devices, and method 500 may proceed to block 504. More specifically, for example, a network device (e.g., a router) may attempt to detect one or more network devices (e.g., one or more data mules) that are positioned sufficiently close to the network device to allow for communication. The one or more network devices may be detected via any suitable method, such as detection of a wireless communication signal.

At block 504, a determination may be made as to whether one or more network devices are detected. If it is determined that one or more network devices are detected, method 500 may proceed to block 506. If it is determined that at least one network device is not detected, method 500 may return to block 502.

At block 506, a determination may be made as to whether a MAC address for a detected network device is in a hit rate table of the network device. For example, with reference to FIG. 2, network device 120A (e.g., the router) may determine whether a MAC address for detected network 120B is in the hit rate table of network device 120A. If it is determined that a MAC address for the detected network device is in the hit rate table, method 500 may proceed to block 508. If it is determined that a MAC address for a detected network device is not in the hit rate table, method 300 may proceed to block 510. It is noted that this act may be performed for each detected network device.

At block 508, the interface ID for the detected network device may be maintained, and method 500 may return to block 502. For example, the interface ID previously assigned to the detected network device may be maintained.

At block 510, the MAC address for the detected network device may be added to the hit rate table, an interface ID may be assigned to the detected network device, and method 500 may return to block 502.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

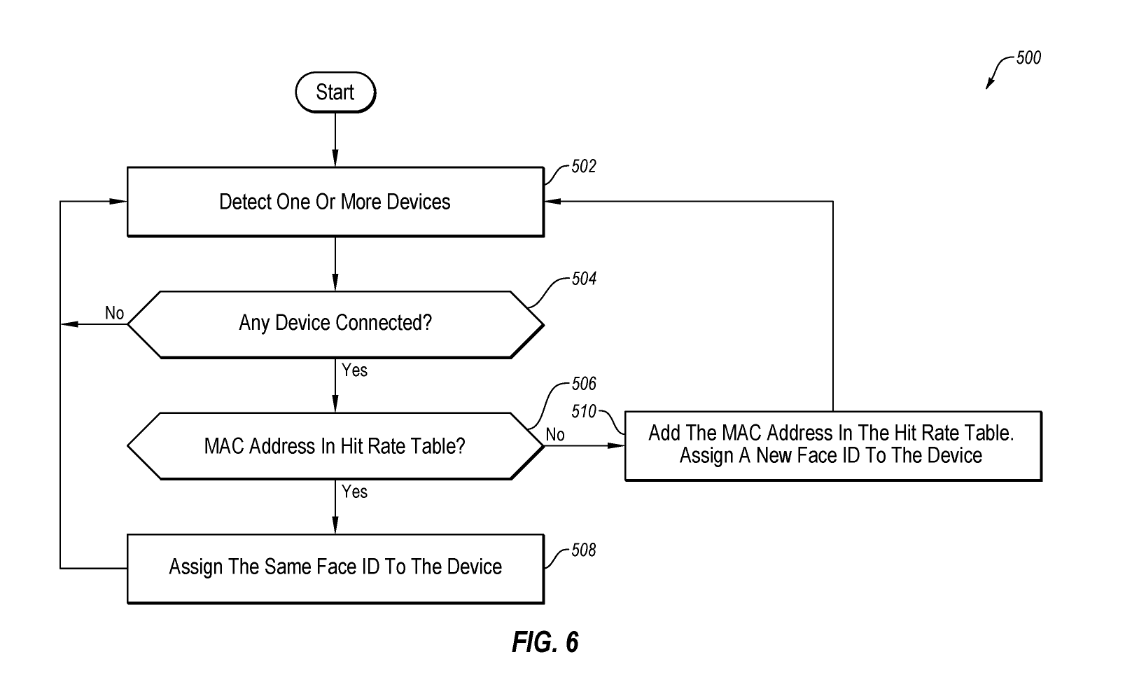

FIG. 6 is a flowchart of an example method 600 for updating a hit rate table of a transmitting network device, in accordance with at least one embodiment of the present disclosure. Method 600 may be performed by any suitable system, apparatus, or device. For example, system 100 of FIG. 1, system 160 of FIG. 2, or one or more of the components thereof may perform one or more of the operations associated with method 600. In these and other embodiments, program instructions stored on a computer readable medium may be executed to perform one or more of the operations of method 600.

At block 602, an interest packet may be forwarded from the transmitting network device to an interface of a receiving network device, and method 600 may proceed to block 604. For example, an interest packet may be forwarded from network device 120A of FIG. 2 to network device 120D.

At block 604, a number of interests for the interface of the receiving network device may be increased in the hit rate table of the transmitting device, and method 600 may proceed to block 606. For example, the number of interest may be increased by one (e.g., Num.Interests=Num.Interests+1).

At block 606, a hit rate for the interface of the receiving network device may be updated in the hit rate table of the transmitting device, and method 600 may proceed to block 608. For example, the hit rate for the interface of the receiving network device may be set equal to the number of hits divided by the number of interests (e.g., hit rate=Num.Hits/Num.Interests).

At block 608, a determination may be made as to whether a data packet, in response to the sent interest packet, is received at the transmitting network device prior to expiration of a time period for the corresponding PIT entry at the transmitting network device. If it is determined the data packet is received prior to expiration of the time interval, method 600 may proceed to block 610. If it is determined that the time interval has expired prior to receipt of the data packet, method 600 may proceed to block 614.

At block 610, a number of hits for the interface of the receiving network device may be increased in the hit rate table of the transmitting device, and method 600 may proceed to block 612. For example, the number of hits may be increased by one (e.g., Num.Hits=Num.Hits+1).

At block 612, a hit rate for the interface of the receiving network device may be updated in the hit rate table of the transmitting device, and method 600 may proceed to block 614. For example, the hit rate may be set equal to the number of hits divided by the number of interests (e.g., hit rate=Num.Hits/Num.Interests).

Modifications, additions, or omissions may be made to method 600 without departing from the scope of the present disclosure. For example, the operations of method 600 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

In one embodiment, a time period for expiration of a PIT entry may be adjusted (e.g., set to a relatively long time) depending on a use case. Further, a service provider may have a policy regarding a maximum number M of data mules the may be used to forward and/or store the same interest packet. (e.g., M>=1).

According to various embodiments, data mules with interfaces having the greatest hit rate (also referred to herein as “highest hit rate”) may be selected to receive, forward, and/or store an interest packet. Interfaces with the highest hit rate are usually interfaces of data mules that are moving relatively fast and/or have relatively large cache. In one embodiment, if more than one interface has the same “highest” hit rate, an interface to receive an interest packet may be selected according to various criteria (e.g., operational policies). For example, the interest packet may be forwarded to one or more interfaces that have received fewer interest packets relative to one or more other interfaces (e.g., for load balancing), the interest packet may be forwarded to one or more that have received more interest packets relative to one or more other interfaces (e.g., for potential better performance), or the interest packet may be forwarded to one or more randomly selected interfaces (e.g., for simplicity).

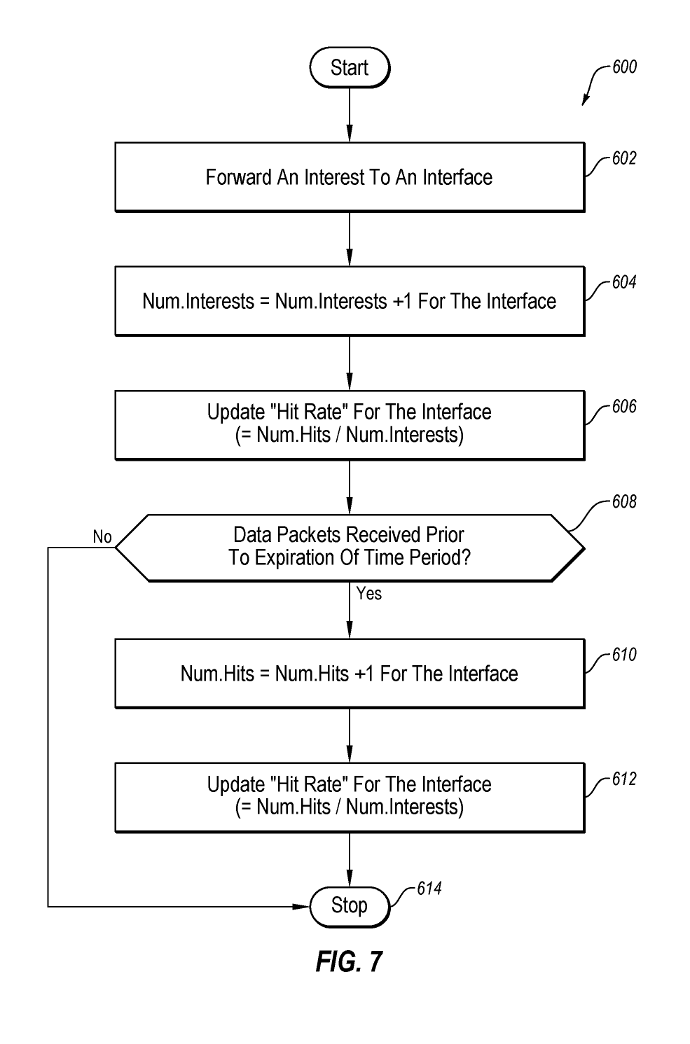

FIG. 7 is a flowchart of an example method 700 for forwarding an interest packet and/or selecting one or more receiving network devices, in accordance with at least one embodiment of the present disclosure. Method 700 may be performed by any suitable system, apparatus, or device. For example, system 100 of FIG. 1, system 160 of FIG. 2, or one or more of the components thereof may perform one or more of the operations associated with method 700. In these and other embodiments, program instructions stored on a computer readable medium may be executed to perform one or more of the operations of method 700.

At block 702, a maximum number M of receiving network devices allowed to receive and/or carry the same interest packet may be determined (e.g., via a service provider's policy), and method 700 may proceed to block 704. For example, the maximum number M of network devices allowed to receive and/or carry the same interest packet, as set by a service provider's policy, may be determined.

At block 704, a determination may be made as to whether a number N of detected neighboring network devices (e.g., in communication with a transmitting network device) is greater than or equal to M, or less than M. If the number N of detected network devices is greater than or equal to the number M of network devices allowed to receive and/or carry the same interest packet (N>=M), method 700 may proceed to block 706. If the number N of detected network devices is less than the maximum number M of receiving network devices allowed to receive and/or carry the same interest packet (N<M), method 700 may proceed to block 710.

At block 706, one or more detected network devices having a greatest hit rate may be selected to receive an interest packet from the transmitting network device, and method 700 may proceed to block 708. In one embodiment, if more than M detected network devices have the same “greatest” hit rate, M network devices to receive an interest packet may be selected according to various criteria (e.g., operational policies). For example, the interest packet may be forwarded to M network devices that have received fewer interest packets (e.g., for load balancing), the interest packet may be forwarded to M network devices that have received more interest packets (e.g., for potential better performance), or the interest packet may be forwarded to M network devices that are randomly selected (e.g., for simplicity).

At block 708, the interest may be forwarded to the M network devices, and method 700 may end at block 718.

At block 710, all N network devices may be selected, and the interest packet may be forwarded to N network devices.

At block 712, a determination may be made as to whether additional network devices are detected. If it is determined that additional network devices are not detected, method 700 may return to block 712. If it is determined that additional network devices are detected, method 700 may proceed to block 714.

At block 714, additionally detected network devices having the greatest hit rate may be selected, and the interest packet may be forwarded to the additionally detected network devices having the greatest hit rate, and method 700 may proceed to block 716.

At block 716, a determination may be made as to whether a number of network devices that have received the interest packet is equal to the maximum number M of receiving network devices. If it is determined that the number of network devices that have received the interest packet is equal to the maximum number M of receiving network devices, method 700 may end at block 718. If it is determined that the number of network devices that have received the interest packet is less than the maximum number M of receiving network devices, method 700 may return to block 712.

Modifications, additions, or omissions may be made to method 700 without departing from the scope of the present disclosure. For example, the operations of method 700 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

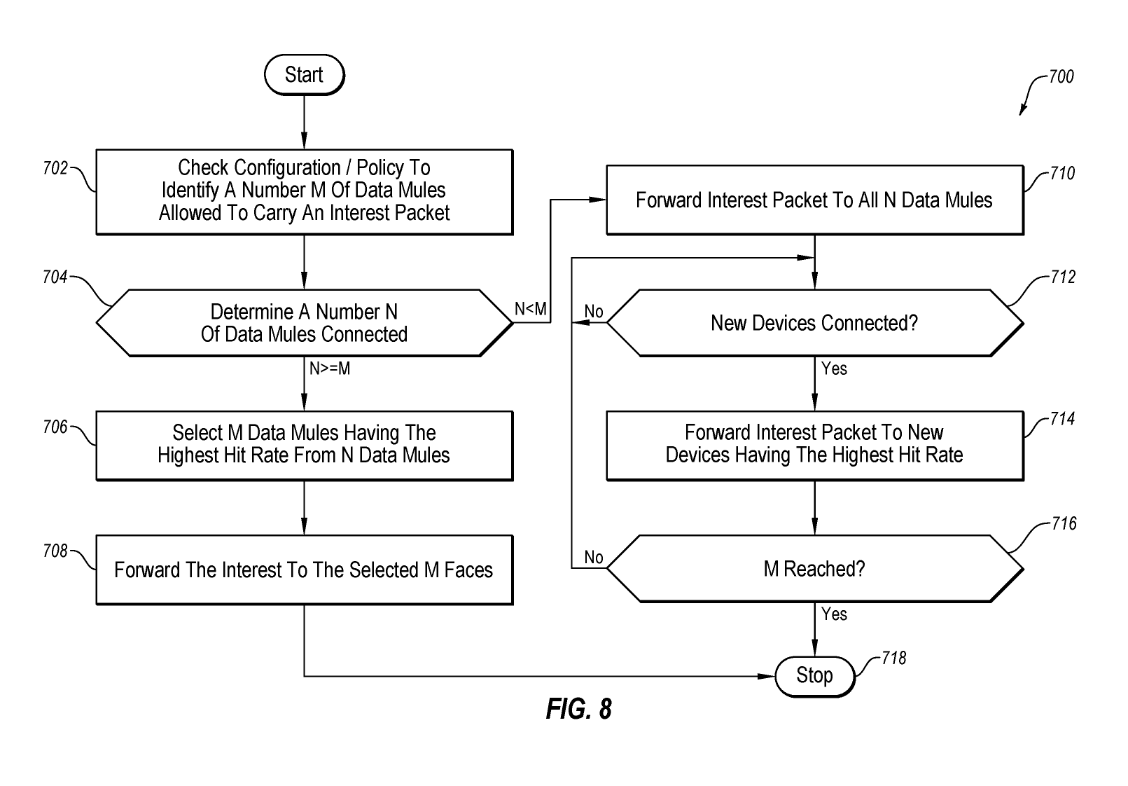

FIG. 8 is a block diagram of an example computing device 800, in accordance with at least one embodiment of the present disclosure. Any of data consumer 110 and/or network devices 120 (of FIG. 1 and/or FIG. 2) may be implemented as computing device 800. Computing device 800 may include a desktop computer, a laptop computer, a server computer, a tablet computer, a mobile phone, a smartphone, a personal digital assistant (PDA), an e-reader device, a network switch, a network router, a network hub, other networking devices, or other suitable computing device.

Computing device 800 may include a processor 810, a storage device 820, a memory 830, and a communication component 840. Processor 810, storage device 820, memory 830, and/or communication component 840 may all be communicatively coupled such that each of the components may communicate with the other components. Computing device 800 may perform any of the operations described in the present disclosure.

In general, processor 810 may include any suitable special-purpose or general-purpose computer, computing entity, or processing device including various computer hardware or software modules and may be configured to execute instructions stored on any applicable computer-readable storage media. For example, processor 810 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 8, processor 810 may include any number of processors configured to perform, individually or collectively, any number of operations described in the present disclosure.

In some embodiments, processor 810 may interpret and/or execute program instructions and/or process data stored in storage device 820, memory 830, or storage device 820 and memory 830. In some embodiments, processor 810 may fetch program instructions from storage device 820 and load the program instructions in memory 830. After the program instructions are loaded into memory 830, processor 810 may execute the program instructions.

For example, in some embodiments one or more of the processing operations of a process chain may be included in data storage 820 as program instructions. Processor 810 may fetch the program instructions of one or more of the processing operations and may load the program instructions of the processing operations in memory 830. After the program instructions of the processing operations are loaded into memory 830, processor 810 may execute the program instructions such that computing device 800 may implement the operations associated with the processing operations as directed by the program instructions.

Storage device 820 and memory 830 may include computer-readable storage media for carrying or having computer-executable instructions or data structures stored thereon. Such computer-readable storage media may include any available media that may be accessed by a general-purpose or special-purpose computer, such as processor 810. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 810 to perform a certain operation or group of operations.

In some embodiments, storage device 820 and/or memory 830 may store data associated with an ICN network. For example, storage device 820 and/or memory 830 may store a PIT, a forwarding information base (FIB), a content store and/or a hit rate table.

Communication component 840 may include any device, system, component, or collection of components configured to allow or facilitate communication between computing device 800 and a network (e.g., network 150 of FIG. 1) For example, communication component 840 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication component 840 may permit data to be exchanged with any network (including network 150) such as a cellular network, a Wi-Fi network, a MAN, an optical network, etc., to name a few examples, and/or any other devices described in the present disclosure, including remote devices.

In some embodiments, communication component 840 may provide for communication within an ICN network. For example, communication component 840 may include one or more interfaces. In some embodiments, communication component 840 may include logical distinctions on a single physical component, for example, multiple interfaces across a single physical cable or optical signal.

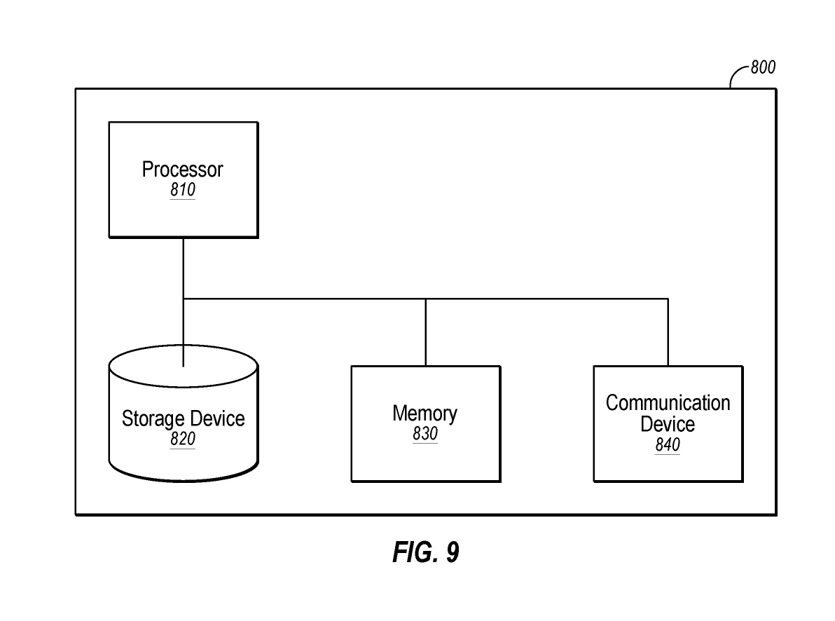

Modifications, additions, or omissions may be made to FIG. 9 without departing from the scope of the present disclosure. For example, computing device 800 may include more or fewer elements than those illustrated and described in the present disclosure. For example, computing device 800 may include an integrated display device such as a screen of a tablet or mobile phone or may include an external monitor, a projector, a television, or other suitable display device that may be separate from and communicatively coupled to computing device 800.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of forwarding a packet in an information centric networking (ICN) network, the method comprising:
determining a hit rate for each detected network device of one or more detected network devices;
selecting at least one network device of the one or more detected network devices having a greatest hit rate; and
sending an interest packet to the at least one selected network device.

2. The method of claim 1, further comprising determining a maximum number of network devices to carry the interest packet.

3. The method of claim 1, further comprising updating a hit rate table after at least one of sending the interest packet to the at least one selected network device and receiving a data packet from the at least one selected network device.

4. The method of claim 1, further comprising assigning an interface ID to a detected network device of the one or more detected network devices.

5. The method of claim 4, wherein the assigning an interface ID comprises:
adding a unique identifier of the detected network device to a hit rate table of a transmitting network device; and
adding the interface ID assigned to the detected network device to the hit rate table.

6. The method of claim 4, further comprising clearing an interface ID entry for the detected network device after expiration of a predetermined time period.

7. The method of claim 1, wherein the determining the hit rate for each detected network device comprises accessing a hit rate table of a transmitting network device including the hit rates for each detected network device.

8. The method of claim 1, wherein the sending an interest packet to the at least one selected network device comprises sending the interest packet to one or more network devices based on at least one of random selection of the at least one selected network device and a number of interest packets previously served by each selected network device of the at least one selected network device.

9. One or more non-transitory computer-readable media that include instructions that, when executed by one or more processors, are configured to cause the one or more processors to perform operations, the operations comprising:
determining a hit rate for each detected network device of one or more detected network devices;
selecting at least one network device of the one or more detected network devices having a greatest hit rate; and
sending an interest packet to the at least one selected network device.

10. The computer-readable media of claim 9, the operations further comprising determining a maximum number of network devices to carry the interest packet.

11. The computer-readable media of claim 9, the operations further comprising updating a hit rate table after sending the interest packet to the at least one selected network device.

12. The computer-readable media of claim 9, the operations further comprising assigning an interface ID to a detected network device of the one or more detected network devices.

13. The computer-readable media of claim 12, wherein the assigning an interface ID comprises:
adding a unique identifier of the detected network device to a hit rate table of a transmitting network device; and
adding the interface ID assigned to the detected network device to the hit rate table.

14. The computer-readable media of claim 9, wherein the determining the hit rate for each detected network device comprises accessing a hit rate table of a transmitting network device including the hit rates for each detected network device.

15. A network device for operating in an information centric networking (ICN) network, the network device comprising:
one or more processors; and
a memory storing computer-readable instructions that, when executed by the one or more processors, are configured to cause the one or more processors to perform operations, the operations comprising:
determining a hit rate for each detected network device of one or more detected network devices;
selecting at least one network device of the one or more detected network devices having a greatest hit rate; and
sending an interest packet to the at least one selected network device.

16. The network device of claim 15, wherein the memory includes a hit rate table including a hit rate for each detected network device of the one or more detected network devices.

17. The network device of claim 16, wherein the determining the hit rate for each detected network device comprises accessing the hit rate table.

18. The network device of claim 16, the operations further comprising updating the hit rate table after sending the interest packet to the at least one selected network device.

19. The network device of claim 16, the hit rate table including:
a number of interest packets forwarded to each detected network device of the one or more detected network devices;
a number of data packets received by the network device from each detected network device of the one or more detected network devices in response to a sent interest packet; and
a hit rate for each detected network device of the one or more detected network devices.

20. The network device of claim 15, wherein the determining a hit rate for each detected network device of one or more detected network devices comprises determining a hit rate for each detected data mule of one or more detected data mules.
